(19) United States
(12) Patent Application Publication
(10) Pub. No.: US 2003/0138677 A1
(43) Pub. Date: Jul. 24, 2003

(54) Method for separating carbon dioxide out of a mixture of water and fuel, and corresponding device

(76) Inventor: Walter Preidel, Erlangen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/368,155

(22) Filed: Feb. 18, 2003

Related U.S. Application Data
(63) Continuation of application No. PCT/DE01/02910, filed on Jul. 31, 2001.

(30) Foreign Application Priority Data
Aug. 16, 2000 (DE) 100 39 960.6

(51) Int. Cl. B01D 61/42

(52) U.S. Cl. 429/12; 204/157.3; 204/450

(57) ABSTRACT

Carbon dioxide is to be removed from the water and fuel mixture present in a fuel cell. A separation installation, which operates according to the principle of electro-osmosis, is used for carrying out the separation. The separation installation has a membrane that is permeable to both fuel and water. The corresponding device has a separation installation, which operates according to the principle of electro-osmosis and forms part of the complete fuel-cell facility.

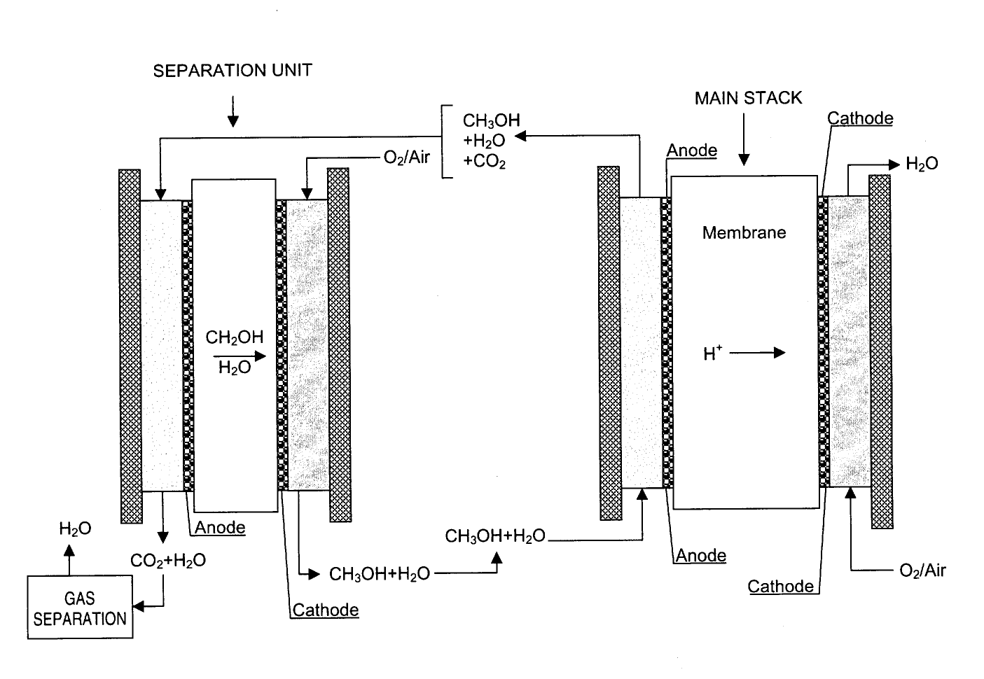

### CROSS-REFERENCE TO RELATED APPLICATION

This application is a continuation of copending International Application No. PCT/DE01/02910, filed Jul. 31, 2001, which designated the United States and which was not published in English.

### BACKGROUND OF THE INVENTION

### Field of the Invention

The invention relates to a method for separating carbon dioxide out of a mixture of water and fuel, in particular out of a water/fuel mixture which is present in a fuel cell. In addition, the invention also relates to a device having means for carrying out the method, having a separation unit for separating carbon dioxide out of a water/fuel mixture. In the invention, the fuel is preferably, although not exclusively, methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline, ethanol or methanol. A DMFC (“Direct Methanol Fuel Cell”) operates directly with methanol as fuel. The function and status of the DMFCs are described in detail by this inventor in “VIK-Berichte”, No. 214 (November 1999), pages 55-62.

The separation of carbon dioxide out of a mixture of water and methanol is a major problem in the circulation of the anode liquid of the methanol-operated fuel cell. The gaseous carbon dioxide should be separated from the liquid methanol/water mixture at the highest possible temperature—if possible the operating temperature of the fuel cell. It is desirable for the temperature to be as high as possible since the solubility of carbon dioxide decreases as the temperature rises, and the effort of cooling the liquid mixture is not required, but rather simply reduces the efficiency of the overall system. However, since the carbon dioxide carries with it a large quantity of methanol without additional cooling, on account of the high methanol partial pressure (boiling point T_{S}=65° C.), additional cooling of the liquid mixture is required.

In the prior art, the liquid/gas mixture is cooled to well below the boiling point of methanol, the carbon dioxide is made to bubble out at an active surface, and then the liquid/gas mixture is separated in a vessel. Therefore, in principle the gas space always contains a quantity of gaseous methanol which is given, at the prevailing temperature, by the methanol partial pressure and the ratio of partial pressure to overall pressure. Consequently, however, valuable fuel is discharged from the fuel cell system without being utilized and—if it is not converted into carbon dioxide and water with additional air by catalytic combustion at a catalytic converter—is discharged to the environment. The emissions of methanol are subject to the same stipulations as in internal combustion engines and therefore has to be included in the overall hydrocarbon level.

### SUMMARY OF THE INVENTION

It is accordingly an object of the invention to provide a method for separating carbon dioxide out of a mixture of water and fuel, and corresponding device which overcomes the above-mentioned disadvantages of the heretofore-known devices and methods of this general type and which improves the separation of carbon dioxide out of a water/fuel mixture, as well as an associated device that improves the process.

With the foregoing and other objects in view there is provided, in accordance with the invention, a method of separating carbon dioxide out of a mixture of water and fuel, which comprises:

conducting a mixture of water and fuel into a separation unit operating according to the principle of electroosmosis; and

separating carbon dioxide out of the mixture of water and fuel.

In a preferred embodiment, the water/fuel mixture is conducted from a fuel cell to the separation unit.

In other words, a separation unit which operates according to the electroosmosis principle is used for the separation. This avoids the loss of fuel through the fact that the current drawback of the methanol-permeable and water-permeable membrane in a fuel cell is made into an advantage.

In a preferred embodiment of the invention the fuel is methanol.

In accordance with an added feature of the invention, the separation unit has an anode, a cathode, and a membrane, and the method comprises passing an anode liquid through the membrane.

In accordance with an additional feature of the invention, the methanol is carried to the cathode together with the water, leaving behind a carbon dioxide-enriched anode liquid at the anode.

In accordance with another feature of the invention, the anode liquid is conducted to a gas separator and gas and water is separated in the gas separator.

In accordance with a further feature of the invention, the anode liquid is circulated and the resulting cathode liquid is recovered as a water/methanol mixture for further fuel cell reaction.

In accordance with again another feature of the invention, the methanol is carried to the cathode together with the water using the electroosmosis principle, to form a methanol-depleted anode liquid at the anode.

In accordance with again a further feature of the invention, the carbon dioxide is substantially completely separated from the liquid carried to the cathode of the separation unit by way of the electroosmosis principle.

With the above and other objects in view there is also provided, in accordance with the invention, a device for separating carbon dioxide out of a mixture of water and fuel, comprising an electroosmosis cell operating according to the principle of a fuel cell configured to receive a carbon dioxide-laden water/fuel mixture, and to separate out the carbon dioxide from the water/fuel mixture.

The water/fuel mixture in the preferred embodiment is a water/methanol mixture.

In accordance with again an added feature of the invention, the fuel cell has a proton-conducting membrane. Advantageously, the proton-conducting membrane has an equivalent weight of less than 120 or even less than 110.

In accordance with a concomitant feature of the invention, the membrane is formed of a material based on polyperfluoroalkylsulfonic acid.

Other features which are considered as characteristic for the invention are set forth in the appended claims.

Although the invention is illustrated and described herein as embodied in a method for separating carbon dioxide out of a mixture of water and fuel, and corresponding device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single FIGURE is a schematic diagram illustrating an assembly according to the invention with a main stack (illustrated as a single cell) and a separation unit.

### DESCRIPTION OF THE PREFERRED EMBODIMENT

Referring now to the sole FIGURE of the drawing in detail, there is shown a stack on the right-hand side that corresponds to the prior art. There, methanol (CH₃OH) and water (H₂O) is provided as a fuel/water mixture into the anode. The generic reaction causes the methanol to be burned up and for hydrogen ions to traverse the membrane to the cathode. The cathode side of the fuel cell stack, which is supplied with air, outputs water.

While the invention is described in detail with reference to a DMFC (direct methanol fuel cell), wherein the fuel used is methanol, it will be understood that this is but an exemplary embodiment and that the invention is not limited to the specific embodiment.

The anode side, following the anode reaction in the stack, outputs a mixture of water, carbon dioxide, and methanol. The anode output mixture is supplied to a separation unit according to the invention, illustrated on the left-hand side.

A primarily important part of a fuel cell is a membrane electrolyte assembly (MEA), which has a specific methanol-permeable and water-permeable membrane, which is chemically described by polyperfluoroalkylsulfonic acid. A membrane of this type is available under the trade name Nafion® (E. I. DuPont de Nemours). Nafion® membranes are usually characterized by their equivalent weight, the membrane known as the Nafion 117 membrane usually being used especially in DMFC fuel cells. For use in the fuel cell, these membranes are rendered hydrophobic.

In accordance with the method of the invention, the anode liquid is passed through a further cell or further cells with a Nafion membrane, which may also be thinner than the standard Nafion 117 membrane, i.e. Nafion 115 or Nafion 112. Nafion material with a lower equivalent weight, i.e. 105 or 102, is also conceivable.

The lower the resistance of the additional cell, the lower the losses. The additional cell will be referred to below as the separation unit. After passing through the anodes, the anode liquid is passed into this cell or the additional unit of cells in the case of larger stacks, and is actively operated at very high current densities.

The separation unit is operated as an electroosmosis unit. Hydrogen is evolved at the cathode. The lower resistance of the Nafion membranes with a lower equivalent weight or a lower density means that the current density is very high even at low voltages, and therefore the electroosmosis is particularly pronounced. The methanol is carried to the cathode together with the water, a methanol-depleted liquid then remaining at the anode. In this way, the carbon dioxide is completely separated from the liquid carried to the cathode of the separation unit. The cathode liquid can now be reused in the anode circuit of the fuel cell.

In the device described, therefore, what is currently the major drawback of the DMFC, namely the excessively permeable membrane, is turned into an advantage. A device of this type can be used directly in a fuel cell system as an additional unit or cell configuration.

The solution to the problem, namely that of separating carbon dioxide out of the water/fuel mixture, which has been described above on the basis of a DMFC operated with methanol as fuel, can also be transferred to fuel cells which are operated with other fuels.

I claim:

1. A method of separating carbon dioxide out of a mixture of water and fuel, which comprises:
conducting a mixture of water and fuel into a separation unit operating according to the principle of electroosmosis; and
separating carbon dioxide out of the mixture of water and fuel.

2. The method according to claim 1, which comprises conducting a water/fuel mixture from a fuel cell to the separation unit.

3. The method according to claim 1, wherein the fuel is methanol.

4. The method according to claim 1, wherein the separation unit has an anode, a cathode, and a membrane, and the method comprises passing an anode liquid through the membrane.

5. The method according to claim 3, wherein the separation unit has an anode and a cathode, and the method comprises carrying the methanol to the cathode together with the water, to form a carbon dioxide-enriched anode liquid at the anode.

6. The method according to claim 5, which comprises conducting the anode liquid to a gas separator and separating gas and water in the gas separator.

7. The method according to claim 5, which comprises circulating the anode liquid and recovering the resulting cathode liquid as a water/methanol mixture.

8. The method according to claim 2, wherein the separation unit has an anode and a cathode, and the methanol is carried to the cathode together with the water using the electroosmosis principle, to form a methanol-depleted anode liquid at the anode.

9. The method according to claim 8, which comprises substantially completely separating the carbon dioxide from the liquid carried to the cathode of the separation unit by way of the electroosmosis principle.

10. In a method of separating carbon dioxide out of a mixture of water and fuel, the improvement which comprises conducting the mixture of water and fuel to a separation unit operating according to electroosmosis and electroosmitically separating the carbon dioxide from the mixture of water and fuel.

11. A device for separating carbon dioxide out of a mixture of water and fuel, comprising an electroosmosis cell operating according to the principle of a fuel cell configured to receive a carbon dioxide-laden water/fuel mixture, and to separate out the carbon dioxide from the water/fuel mixture.

12. The device according to claim 11, wherein the water/fuel mixture is a water/methanol mixture.

13. The device according to claim 11, wherein the fuel cell has a proton-conducting membrane.

14. The device according to claim 13, wherein the proton-conducting membrane has an equivalent weight of less than 120.

15. The device according to claim 13, wherein the proton-conducting membrane has an equivalent weight of less than 110.

16. The device according to claim 13, wherein the membrane is formed of a material based on polyperfluoroalkylsulfonic acid.
